(19) United States
(12) Patent Application Publication
(10) Pub. No.: US 2022/0338101 A1
(43) Pub. Date: Oct. 20, 2022

(54) MOTION-BASED BEACON ADVERTISEMENT

(71) Applicant: Hall Labs LLC, Provo, UT (US)

(72) Inventors: David R Hall, Provo, UT (US); Mark Hall, Smithfield, UT (US); John Robinson, Spanish Fork, UT (US)

(73) Assignee: Hall Labs LLC, Provo, UT (US)

(21) Appl. No.: 17/232,102

(22) Filed: Apr. 15, 2021

(51) Int. Cl. H04W 48/12; H04W 4/80

(52) U.S. Cl. CPC H04W 48/12; H04W 4/80; G01V 11/00

(57) ABSTRACT

Systems, devices, and methods for motion-based beacon advertisement are disclosed. A motion detector (e.g., request to enter detector) includes a motion sensor, a first Bluetooth® radio that operates in a beacon mode, and a controller that executes instructions. The instructions cause the controller to detect a motion event via the motion sensor, initiate a timer for a predetermined time in response to the detected motion event, broadcast a beacon message in response to the detected motion event via the Bluetooth® radio, and terminate the broadcast of the beacon message upon expiration of the timer.

### CROSS REFERENCE TO RELATED APPLICATIONS

The present application for patent claims priority to U.S. Provisional Application No. 63/010,439 entitled “MOTION BASED BEACON ADVERTISEMENT” filed Apr. 15, 2020, and assigned to the assignee hereof and hereby expressly incorporated herein by reference.

### TECHNICAL FIELD

The described systems and methods are directed to motion sensors. In particular, the described systems and methods are directed to motion sensors for enabling secure access.

### BACKGROUND

Access control systems are used to restrict access to a geographic location or item. The basic principle of access control is that access to a particular geographical location or device is secured using some form of a locking mechanism that is only accessible using an authorized key. The traditional example of an access control system is a physical lock with one or more physical keys that physically engage with the locking mechanism and unlock the locking mechanism to enable access. With the rise of digital technology and information networking, physical locks and physical keys have given way to electronic locks and digital keys (e.g., passcodes, passwords, radio frequency identification (RFID) tags, and the like). One of the benefits of digital keys is easier/cheaper key management, and per-user key granularity.

RFID based access control systems are ubiquitous (from building access to parking access, and the like, for example) and have become the default choice for digital key-based access control systems. The problem with RFID based access control systems, however, is that they still require a user to present a physical electronic key device (e.g., an RFID tag, RFID card, RFID fob) to a reader to obtain access. Thus, despite the switch from physical keys to digital keys, RFID systems still require that the user keep with them a physical fob or other extra device (that includes an RFID tag, for example).

### SUMMARY

In a first aspect, the disclosure describes a method for motion-based beacon advertisement. The method includes detecting a motion event via a motion sensor, initiating a timer for a predetermined time in response to the detected motion event, broadcasting a beacon message in response to the detected motion event, and terminating the broadcast of the beacon message upon expiration of the timer.

In a second aspect, the disclosure provides that the beacon message uses a Bluetooth Low Energy (BLE) advertisement frame.

In a third aspect, the disclosure provides that the Bluetooth advertising frame includes a data payload that includes a byte sequence associated with a beacon format. The beacon format is one of an AltBeacon format, iBeacon format, or Eddystone format.

In a fourth aspect, the disclosure provides that broadcasting the beacon message involves repetitively broadcasting the beacon message according to an advertising interval.

In a fifth aspect, the disclosure provides that the method further includes initiating the broadcast of the beacon message upon initiation of the timer.

In a sixth aspect, the disclosure provides that the method further includes limiting a transmit power for the broadcast of the beacon message based on a coverage area of the motion sensor.

In a seventh aspect, the disclosure provides that the method further includes transmitting the beacon message via a directional antenna. The directional antenna directs the beacon message toward a coverage area of the motion sensor.

In an eighth aspect, the disclosure provides that the predetermined time is less than 30 seconds.

In a ninth aspect, the disclosure provides that the predetermined time is less than 10 seconds.

In a tenth aspect, the disclosure provides that detecting a motion event includes detecting a motion event in an external area to an access barrier. The access barrier separates the external area from an internal area.

In an eleventh aspect, the disclosure provides a device for motion-activated beacon advertisement. The device includes a motion sensor, a Bluetooth® radio, a processor, and memory in electronic communication with the processor. The memory stores instructions that when executed by the processor cause the processor to detect a motion event via the motion sensor, initiate a timer for a predetermined time in response to the detected motion event, broadcast a beacon message via the Bluetooth radio in response to the detected motion event, and terminate the broadcast of the beacon message upon expiration of the timer.

In a twelfth aspect, the disclosure provides that the beacon message uses a Bluetooth® Low Energy (BLE) advertisement frame.

In a thirteenth aspect, the disclosure provides that the BLE advertising frame includes a data payload that includes a byte sequence associated with a beacon format. The beacon format is one of an AltBeacon format, iBeacon format, or Eddystone format.

In a fourteenth aspect, the disclosure provides that the instructions to broadcast the beacon message include instructions that are executable by the processor to repetitively broadcast the beacon message according to an advertising interval.

In a fifteenth aspect, the disclosure provides that the instructions are further executable by the processor to initiate the broadcast of the beacon message upon initiation of the timer.

In a sixteenth aspect, the disclosure provides that the instructions are further executable by the processor to limit a transmit power for the broadcast of the beacon message based on a coverage area of the motion sensor.

In a seventeenth aspect, the disclosure provides that the instructions are further executable by the processor to transmit the beacon message via a directional antenna. The directional antenna directs the beacon message toward a coverage area of the motion sensor.

In an eighteenth aspect, the disclosure provides that the predetermined time is less than 30 seconds.

In a nineteenth aspect, the disclosure provides that the predetermined time is less than 10 seconds.

In a twentieth aspect, the disclosure provides that the instructions to detect a motion event include instructions that when executed by the processor cause the processor to detect a motion event in an external area to an access barrier. The access barrier separates the external area from an internal area.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates an exemplary environment depicting an external side of a door and doorway in which the described systems, methods, and devices may be implemented.

FIG. 2 illustrates an exemplary environment depicting the internal side of the door and the doorway illustrated in FIG. 1.

FIG. 3 is a perspective diagram of a request to enter detector.

FIG. 4 is a block diagram illustrating one example of a request to enter detector.

FIG. 5 is a block diagram illustrating an access control system that includes a request to enter detector.

FIG. 6 is a block diagram illustrating another access control system that includes a request to enter detector.

FIG. 7 is a block diagram illustrating another access control system that includes a request to enter detector.

FIG. 8 is flow diagram illustrating one example of a method for motion-based beacon advertisement.

FIG. 9 is flow diagram illustrating another example of a method for motion-based beacon advertisement.

FIG. 10 is flow diagram illustrating yet another example of a method for motion-based beacon advertisement.

FIG. 11 is a block diagram of a computing device for implementing the described systems and methods.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Access control systems are used to physically secure/restrict access to a geographic area (e.g., a building, a room, a closet, a case, a parking garage, a pool, a gym, etc.) or a device (e.g., authenticate use of item, pay to use an item, etc.). As described herein, access control is described with respect to securing/restricting access to a geographic area (e.g., a building, a room, a closet, etc.). Although the following description describes secure access with respect to securing a geographical area, it is appreciated that the describe systems may similarly be applied to other embodiments of secure access.

Historically, access control was implemented using mechanical locks and mechanical keys that physically engage with the locking mechanism in the mechanical lock to mechanically unlock the locking mechanism and allow access (when an authorized key is used, for example). In these traditional mechanical lock and key access control systems, a user must possess a mechanical key to unlock the mechanical lock. As technology has progressed, mechanical locks have been replaced with electromechanical locks and mechanical keys have been replaced with digital keys (e.g., passcodes, passwords, Bluetooth beacons, radio frequency identification (RFID), and the like). In these electromechanical lock and digital key access control systems, the digital key is provided to a controller that authorizes the digital key and that unlocks the electromechanical lock via control signals that control the electromechanical lock (supply a voltage/current that electrically unlocks the electromechanical lock, for example). It is appreciated that digital keys allow for detailed logging of access as well increased user granularity.

Because of the nature of digital keys, there are many ways in which digital keys (e.g., credentials) may be provided, including passcodes, passwords, RFID signals, electronic messages, and the like. It is appreciated that each implementation comes with different strengths and weaknesses. For example, passcodes and passwords don't require a user to possess/carry any extra devices (e.g., key or fob, etc.), but does require a user to physically input the passcode/password (e.g., credentials) into an input device (e.g., keypad, keyboard), which is a slow way to provide credentials. RFID systems on the other hand provide credentials by presenting an RFID tag to the RFID reader, which is much faster way to provide credentials than manually inputting the credentials but requires a user to possess/carry an RFID tag. It would be beneficial to have the convenience of quick way of providing credentials while not requiring a user to carry a separate key (e.g., RFID tag/card/fob).

The described systems and methods provide a digital access control system that uses a motion detector and user's electronic device (e.g., phone, watch, tablet, etc.) to enable a seamless way of providing access credentials that does not require the use of a separate key (e.g., RFID tag/fob/card). In one example, a motion detector detects motion in a limited area that is near/in proximity to the door (e.g., an area that extends in front of the door, similar to an area detected by a request to exit detector, for example). In response to the detected motion, a beacon signal (e.g., Bluetooth beacon, Bluetooth Low Energy (BLE) advertisement frame) is transmitted for a predetermined time period. The beacon signal may be power controlled and/or limited to target the area covered by the motion detector. The user's electronic device (e.g., an application installed on the electronic device) receives the beacon signal and presents a notification to the user in response to the notification. The notification may be an actionable notification that allows the user to provide at least one input (e.g., an unlock button). The user can optionally provide an input to indicate the request to access. Upon receiving the input requesting access, the electronic device (e.g., an application installed on the electronic device) connects to a controller associated with the received beacon signal. The actual credential exchange can be implemented in a variety of ways. For instance, simply making a Bluetooth connection with the controller by a the electronic device (which is a known device) may be a sufficient credential for access. In a different embodiment, an access credential may be provided by an application to the controller via a Bluetooth connection once the Bluetooth connection is established. As with other systems, received credentials are verified and access is provided when the received credentials are properly authorized.

It is appreciated that the wireless signals associated Bluetooth and similar wireless technologies can travel larger distances (e.g., 10 meter (m)-100 m). In typical buildings, multiple doors/access control points within this larger distance. As a result, if beacon signals were transmitted continuously and/or without limitation, then users all over the building would constantly be bombarded with beacons signals from multiple doors, which is very inconvenient and undesirable. The use of the motion detector to trigger the broadcasting of beacon signals for a predetermined period (e.g., 2 -10 seconds, 3 -5 seconds) and/or limitations (e.g., transmit power limitations to limit transmit distance of the beacon signal, and/or directional focus of the transmission to direct the coverage area of the beacon signal) along with a separate Bluetooth connection allows for the effective use these signals to provide seamless access control for users using their own electronic device(s).

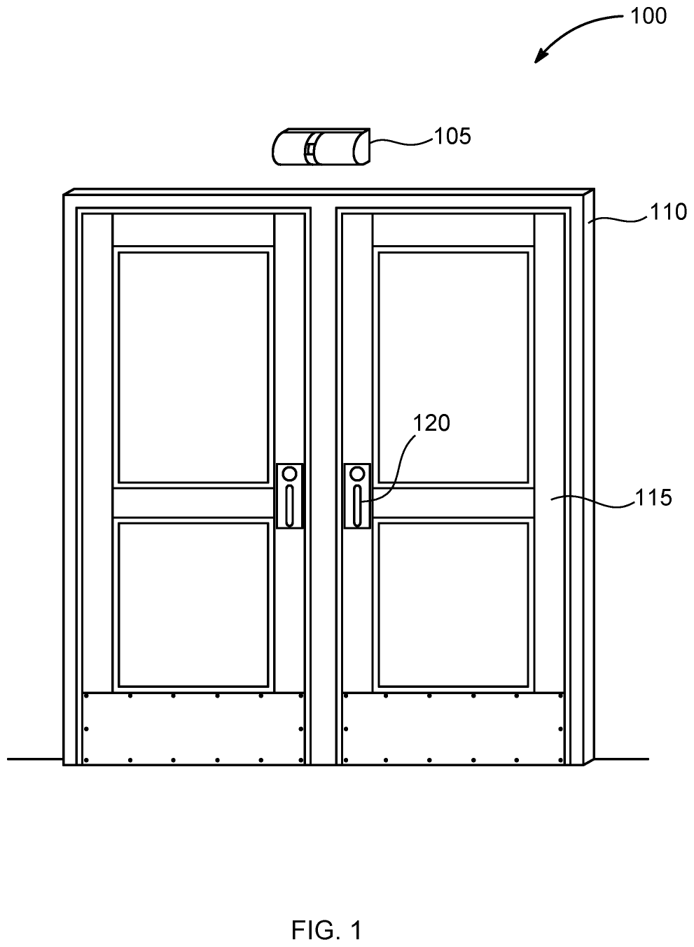

Referring now to the figures, FIG. 1 illustrates an exemplary environment 100 depicting an external side of a door 115 and doorway 110 in which the described systems, methods, and devices may be implemented. It is understood that a doorway 110 provides ingress and/or egress to an enclosure and that the door 115 is a barrier in the doorway 110 that selectively secures the enclosure. As used herein, the side of the door 115 that faces the enclosure is referred to as the internal side of the door 115 and the side of the door 115 that is opposite to the internal side of the door 115 (e.g., faces away from the enclosure) is referred to as the external side of the door 115. It is appreciated that the door 115, which is selectively able to secure the doorway 110, provides an ideal environment 100 where the described systems, methods, and devices may be used to provide an improved access control experience.

The exemplary environment 100 includes a motion detector 105 (also referred to herein as a request to enter detector 105), a doorway 110, a door 115, and a door handle 120. The motion detector 105 is mounted near (e.g., above, in this case) the doorway 110 and faces (e.g., performs motion detection in) an area in front of (e.g., approaching) the external side of the door 115.

The motion detector 105 includes a motion sensor, a Bluetooth® radio, and a controller. The motions sensor may be any type of sensor that can be used to detect a motion (e.g., trigger a motion event), including a passive infrared sensor, a microwave sensor, an ultrasonic sensor, a tomographic sensor, a video camera, or some combination thereof. The Bluetooth® radio may be configured to be in an advertising mode (e.g., beacon mode, broadcast only, for example) for broadcasting advertising messages (and not for establishing a connection with another Bluetooth® device, for example). The controller may selectively enable/disable the broadcasting of advertising messages (e.g., beacon messages) based on motion events detected by the motion sensor. For example, the controller may turn off all beacon message broadcasts when no motion events are detected and may only turn on beacon messages broadcasts for a predetermined time period (e.g., 5 seconds, 10 seconds, or 15 seconds) upon a motion event being detected (e.g., triggered).

In some embodiments, the Bluetooth® radio may only function in an advertising mode (e.g., beacon mode, broadcast only mode). In other embodiments, the Bluetooth® radio (e.g. a single Bluetooth® radio) may be able to switch between an advertising mode (e.g., broadcast only) and a connection mode (e.g., for establishing a communication connection with another Bluetooth® device). As discussed in further detail below, a Bluetooth® connection request itself and/or information exchanged in an established Bluetooth® connection may be used for authentication (e.g., a digital key) for enabling secure access. In yet other embodiments, the motion detector 105 may include two (2) Bluetooth® radios, where the first Bluetooth® radio remains in advertising mode for broadcasting beacon messages and the second Bluetooth® radio remains in connection mode for handling connection requests and connections from other Bluetooth® devices.

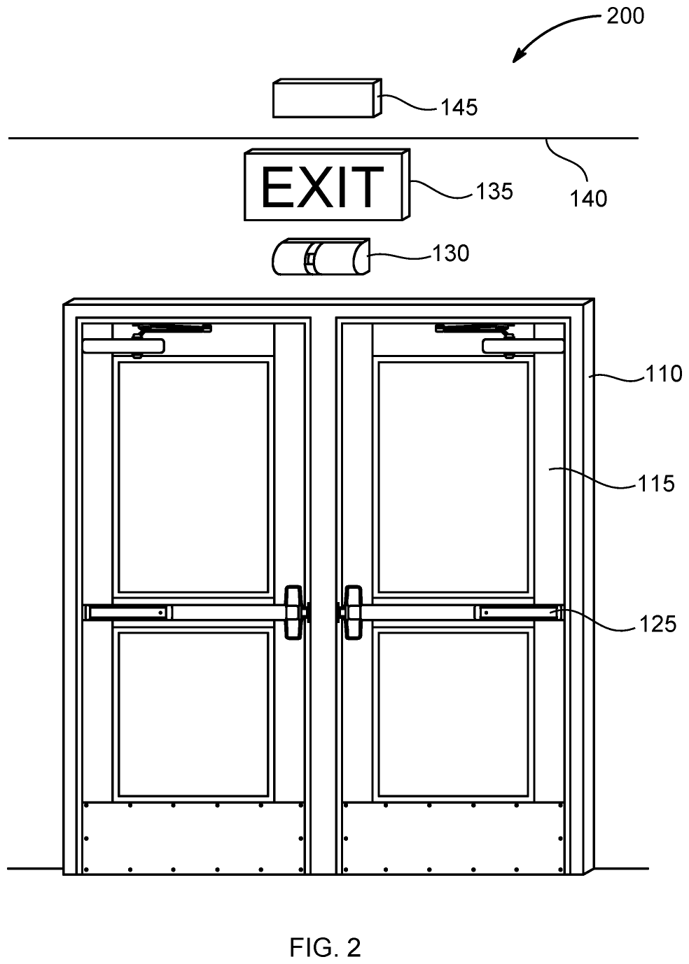

FIG. 2 illustrates an exemplary environment 200 depicting the internal side of the door 115 and the doorway 110 illustrated in FIG. 1. Complementary to the pull handle 120 on the external side of the door 115 in FIG. 1, the internal side of the door 115 includes a push handle 125. The push handle 125 may actuate a latch that latches the door 115.

Although not shown, the door 115 and/or the doorway 110 is enabled with an electronically actuated locking mechanism. Examples of electronically actuated locking mechanisms include electronic strike systems (that use electrically enabled lockable/unlockable jaws, for example), electromagnetic locking systems (that use electrically enabled magnetic forces to lock/unlock, for example), electric deadbolts (that use electrically extend/release a deadbolt or pin to lock/unlock, for example), electric door handles (that electronically enable/disable latch movement, for example), and the like. It is appreciated that described systems and methods may be used with any type of electronically actuated locking mechanisms. It is appreciated that the doorway 110 includes one or more electric strikes (that are designed to not be externally visible) as the electronically actuated locking mechanism for enabling secure access via the door 115 in the doorway 110.

The exemplary environment 200 includes a request to exit detector 130 an exit sign 135, and a control box 145 (located above the ceiling 140, for example). The request to exit detector 130 may be a standard motion detector that unlocks the door 115 in response to a motion event to allow egress (including emergency egress) without any additional actions (e.g., pushing a button). It is appreciated that a request to exit detector 130 may be required by law and/or building codes when using electronically actuated locking mechanisms that access control egress through a doorway 110.

Access control systems typically include a controller that manages access control through the doorway 110. The controller integrates the electronically actuated locking mechanism, any other devices (e.g., the request to enter device 105, the request to exit device 130, keypads, communications systems, and the like) with the access control system (e.g., centrally managed access control system).

The controller is typically located on the internal side of the doorway 110 for security reasons. In the exemplary environment 200, the controller may be implemented in the exit sign 135 or in the control box 145.

In one example, a person having a mobile device (e.g., watch or phone) may approach the doorway 110. When the person enters the area being monitored for motion by the motion detector 105, the motion detector 105 detects a motion event and triggers the Bluetooth® radio to broadcast a series of beacon messages. For example, upon detecting the motion event, the motion detector 105 may initiate a countdown timer for a predetermined period (e.g., 5-20 seconds) and may broadcast a beacon message (e.g., a Bluetooth Low Energy (BLE) service advertisement (i.e., Advertising Data type 0x16) or a BLE manufacturer advertisement (i.e., Advertising Data type 0xff).) every interval (e.g., 0.1 second) until the expiration of the countdown timer. The beacon message may implement any of a variety of beacon protocols/formats, including iBeacon, AltBeacon, URIBeacon, and Eddystone. The coverage area of the broadcast of the beacon message may be limited/focused on the area covered by the motion detector 105 and/or the area immediately surrounding the doorway 110 (an area within a 5-15 foot radius of the Bluetooth® radio for example).

Upon receiving the beacon message transmitted by the motion detector 105, the mobile device may provide a notification to the person that prompts the person with an option to request entry (or to ignore, for example). Assuming the person wishes to enter the doorway 110, the person provides an input (e.g., touch, swipe, voice confirmation, etc.) to the mobile device indicating a request to enter. The mobile device (via a purpose built application, for example) may use information (e.g., a specific identifier identifying a Bluetooth® radio to connect to, a Bluetooth® radio in the control box 145, for example) received in the beacon message to make a Bluetooth® connection request to a particular Bluetooth® radio that is configured for establishing Bluetooth® connections.

In one example, the connection request by the mobile device includes sufficient authentication information for the controller to authenticate access based solely on the information (e.g., the media access control (MAC) address of the Bluetooth® radio of the mobile device, a trusted MAC address registered with the mobile device when the application was installed on the mobile device, for example) provided in the connection request. Alternatively, authentication information may be provided once an established connection is created between the mobile device and the controller. Once authenticated, the controller may actuate the electrically controlled access mechanism to unlock the door and permit access via the unlocked door 115. In this way, the person may provide authentication for access via the doorway 110 by simply responding to a notification on the person's mobile device (e.g., watch, phone, and/or tablet.

It is appreciated that limiting the beacon messages to a predetermined time window in response to a motion event and limiting/tailoring the broadcast area of the beacon messages to an area in close proximity to the door 115 substantially limits the amount of undesirable notifications received by other persons not interested in authenticating for ingress through the door 115. It is further appreciated that unregistered persons who trigger the motion detector 105 without the application will be unaware that beacon messages are being sent and even if they are aware, will be unable to even attempt to authenticate, thus increasing the security of the access control system. Additionally, because the described systems and methods dispense with the need for keypads and RFID readers, access-controlled doorways become indistinguishable to non-access-controlled doorways to the uninitiated. While it is true that including a motion detector 105 on the external side of a doorway 110 is nontraditional, the ubiquitous use of request to exit detectors (e.g., request to exit detector 130) disguises the addition of the motion detector 105 (e.g., request to enter detector 105) on the exterior side of the doorway 110.

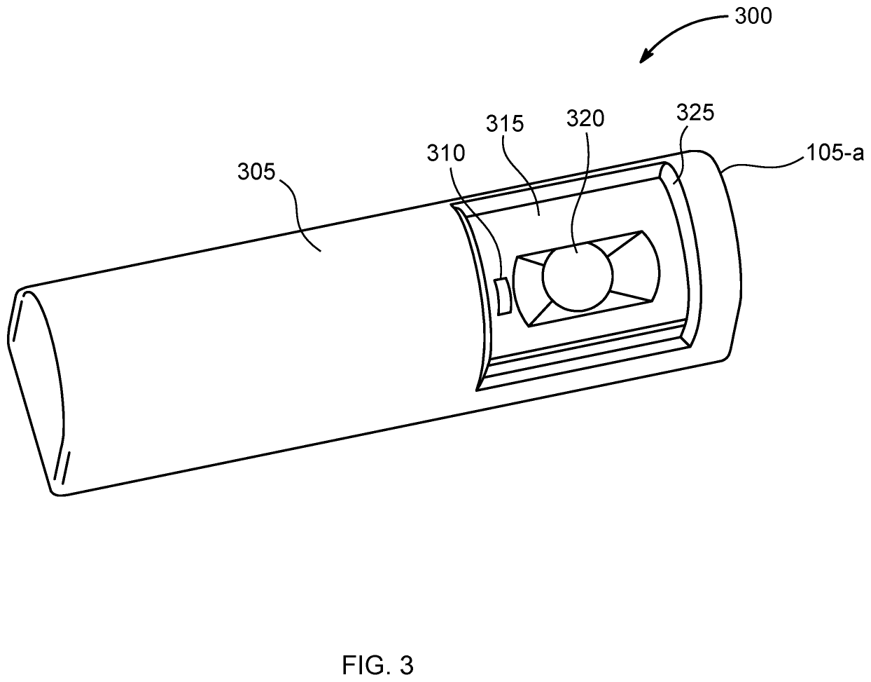

FIG. 3 is a perspective diagram 300 of a request to enter detector 105-a. The request to enter detector 105-a (e.g., motion detector 105-a) is an example of the motion detector 105 illustrated in FIG. 1. The request to enter detector 105-a includes an outer case 305 that includes a window 325 through which, an adjustable motion sensor housing 315 is exposed. The adjustable motion sensor housing 315 includes a motion detected indicator 310, and a motion sensor 320.

It is expected that the request to enter detector 105-a is mounted in an elevated position parallel with the floor/ground (above the door as illustrated in FIG. 1, for example). The adjustable motion sensor housing 315 is adjustable along the horizontal axis of the request to enter detector 105, which enables the motion sensor 320 to cover an area closer to doorway 110 when the adjustable motion sensor housing 315 is adjusted so the motion sensor 320 is located towards the bottom of the window 325 or to cover an area further away from the doorway 110 when the adjustable motion sensor housing 315 is adjusted so that the motion sensor 320 is located towards the middle (e.g., a point perpendicular to the backplane of the request to enter detector 105-a) of the window 325. It is appreciated that the adjustable motion sensor housing 315 enables the coverage area of the motion sensor can be optimized based on the particular use case (including topology of approaching infrastructure, the mounting orientation of the request to enter detector 105-a, etc., for example).

The visible portion of the motion sensor 320 may be the lens (e.g., Fresnel lens) of the motion sensor (e.g., PIR sensor, microwave sensor, ultrasonic sensor, motion sensor described with respect to FIG. 1). It is appreciated that the lens provides the motion sensor 320 a field of view (e.g., coverage area) in which the motion sensor will detect movement. It is further appreciated that the lens and the angle of the adjustable motion sensor housing 315 may be optimized to provide the desired motion detection coverage area in front of the external side of the doorway 110.

From the outside, the request to enter detector 105-a looks similar if not identical to a request to exit detector (e.g., request to exit detector 130). The request to enter detector, however, differs from a request to exit detector by what is included (e.g., hidden beneath the outer case 305) on the inside. For example, the request to enter detector 105-a differs from the request to exit detector by the inclusion of the Bluetooth® radio that operates in a beacon mode and an internal controller that enables the Bluetooth® radio to transmit a series of beacon messages for a predetermined time period (e.g., 5-20 seconds) in response to a motion event detected by the motion sensor 320. In some embodiments, the motion detected indicator 310 (a light emitting diode (LED) behind a diffuser, for example) may be illuminated for the duration (e.g., 5-20 seconds) that the Bluetooth® radio is broadcasting beacon messages to provide a visual indication that both motion was detected and that the Bluetooth® radio is actively broadcasting beacon messages.

Because request to enter detectors (e.g., request to enter detector 105-a) are part of access control systems, request to enter detectors benefit from being coupled to backup power sources (e.g., backup batteries and/or backup/emergency power generation systems), which provide continuing electrical power, even when traditional power to the building is not available (e.g., the power is out). Therefore, secure access using the described systems and methods may still be available even when traditional power sources are not available. In some embodiments, the request to enter detector 105-a may include a batter backup for supplying continuing electrical power even when the traditional source of electrical power is out.

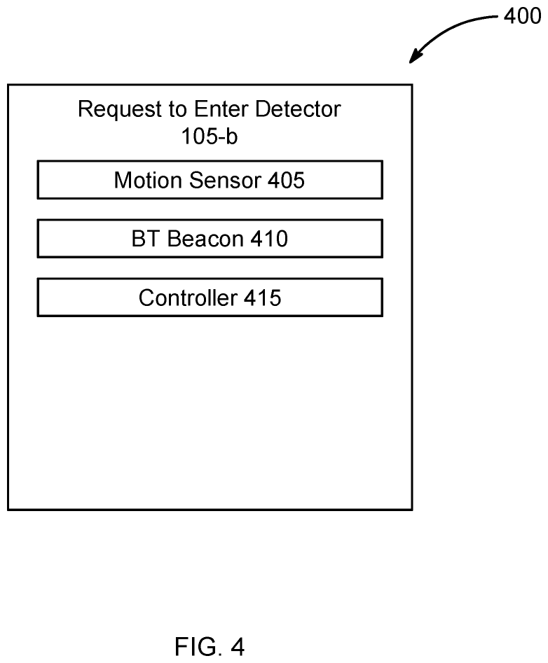

FIG. 4 is a block diagram 400 illustrating one example of a request to enter detector 105-b. The request to enter detector 105-b is one example of the request to enter detector 105 and request to enter detector 105-a illustrated in FIGS. 1 and 3. The request to enter detector 105-b includes a motion sensor 405 (e.g., motion sensor 320), a Bluetooth® (BT) beacon 410, and a controller 415.

The motion sensor 405 may be any type of sensor that can be used to detect motion (e.g., trigger a motion event), including a passive infrared (PIR) sensor, a microwave sensor, an ultrasonic sensor, a tomographic sensor, a video camera, or some combination thereof. In some embodiments, the motion sensor 405 may be of the same type and may perform the same motion detection as a the motion sensor included in a request to exit detector (e.g., request to exit detector 130). The motion sensor 405 may detect motion and may indicate a motion event via a signal. In one example, the motion sensor 405 is wired as a normally closed (NC) sensor so that the circuit between two data wires is (normally) closed when no motion is detected and is opened (for a predetermined amount of time (e.g., 2 seconds), for example) when motion is detected. Accordingly, the signal may be a change in state between a closed circuit and an open circuit (or a change in state between and open circuit and an open circuit, for example).

The motion sensor 405 may limit motion detection to a coverage area defined by the type of motion sensor 405 that is used. For example, a PIR sensor includes a lens (e.g., a Fresnel lens, the lens (e.g., motion sensor 320) illustrated in FIG. 3, for example) that focuses the motion detection of the motions sensor 405 to a particular area that is “covered” within the field of view of the motions sensor 405 via the optics of the lens. As noted previously, the coverage area of the motion sensor 405 may be adjusted by adjusting the lens and/or the angle of the motion sensor 405 as it is positioned by the may be adjusted by the adjustable motion sensor housing 315 as discussed with respect to FIG. 3.

The BT beacon 410 may be a Bluetooth® radio that is configured in advertisement mode (e.g., beacon mode, a broadcast only mode) in which the BT beacon 410 transmits/broadcasts a series of advertisements (e.g., beacon messages) on a set of advertising channels (e.g., on each of BT channels 37, 38, and 39, one after another, for example) according to a Bluetooth® Low Energy (BLE) advertising interval (e.g., less than 100 ms). A beacon message may be a BLE service advertisement with an Advertising Data type of “0x16” or a BLE manufacturer advertisement with an Advertising Data type of “0xff”. In some embodiments, the beacon message may use an ADV_NONCONN_IND type of channel advertising protocol data unit (PDU). The beacon message includes a universally unique identifier (UUID) that is specific to the BT beacon 410. The UUID of the BT beacon 410 may be mapped to a UUID of a second BT device (e.g., a BT device in a controller) that is configured in a connection mode for receiving connection requests and authenticating access.

It is appreciated that the range of BT transmissions can be approximately 100 meters (m) for class 1 BT devices and approximately 10 m for class 2 BT devices. For the purposes of access control, long range is typically beneficial. For example, even 10 m of range at one controlled access doorway may overlap other secured access doorways. Several aspects of the described systems and methods work to minimize undesired notifications to users that have the application/are set up for secure access using the described systems and methods, who are in the range of a BT beacon 410, but not desiring to enter the doorway (e.g., those who are already in the enclosure). Aspects such as only triggering the BT beacon 410 when motion is detected is one way to limit undesired notifications. Another aspect is the placement, antenna design, and transmit power used by the BT beacon 410.

Placement, antenna design, and transmit power of the BT beacon 410 may be optimized to target a broadcast area of the beacon messages to an area that approximates the coverage area of the motion sensor 405. It is first noted that the placement of the request to enter detector 105-b is outside of the enclosure, often pointing away from the enclosure. By pairing this placement with a directional antenna that similarly focuses the broadcast area of the beacon messages to an area in front of the doorway (like the coverage area of the motion sensor 405, for example), the beacon messages can be targeted to cover only the area of interest (i.e., the area confined to the area in front of a doorway). Similarly the transmit power of the BT beacon 410 may be selected (by/via the controller 415, for example) to tailor the broadcast area to the area of interest (the area corresponding to the coverage area of the motion sensor 405, for example).

While the placement of the request to enter detector 105-b is selected at the time of installation and the directional attributes of the BT antenna is generally selected at the time of manufacturing of the BT beacon 410 and/or the request to enter detector 105-b, the transmit power of the BT beacon 410 may be dynamically adjustable via the controller 415.

In some cases, the BT beacon 410 may have a button or sequence that triggers a configuration mode in which the countdown timer length and attributes of the BT beacon 410 (e.g., transmit power, beacon message content, etc.) may be setup through a direct connection with the BT beacon 410. For example, the BT beacon 410 may temporarily use a connection mode to allow for direct connection by a BT device for configuration. The BT beacon 410 may operate exclusively in the advertisement/beacon mode during normal operation.

The controller 415 is coupled to the motion sensor 405 and the BT beacon 410. The controller 415 detects motion events detected by the motion sensor 405 and controls the BT beacon 410 to either disable broadcasting (e.g., not broadcast beacon messages, and sleep, for example) or to enable broadcasting (e.g., actively broadcast beacon messages). In the case of access control, the controller 415 may, by default, disable the BT beacon 410 when no motion is detected by the motion sensor 405. When the motion sensor 405 detects (e.g., signals) a motion event, the controller 415 initiates a countdown timer for a predetermined time period and enables the BT beacon 410 to broadcast beacon messages until the countdown timer expires. When the countdown timer expires, the controller 415 disables the BT beacon 410, which stops the BT beacon 410 from transmitting/broadcasting any beacon messages. If the controller 415 detects subsequent motion events while the countdown timer is running, the controller 415 can restart the countdown timer and/or ignore the subsequent motion events based on the use case/desired operation characteristics.

The controller 415 may be programmable so that the predetermined time that the countdown timer is set to may be adapted to a particular use case or to satisfy operational goals. In one example, the predetermined time may be set to be less than or equal to 15 seconds. In another example, the predetermined time may be set to be less than or equal to 10 seconds. In yet another example, the predetermined time may be set to be less than or equal to 5 seconds. The predetermined time may be minimized as much as possible to reduce undesired notifications while still providing a smooth user experience for the entire authentication process (so that a person may be detected by the motion sensor, the person's mobile device receives a beacon message and provides a notification to the person, and the person can request entry via the notification and the authentication process could occur without the person breaking stride before arriving at the unlocked door, for example).

The controller 415 may control the transmit power used by the BT beacon 410. In some embodiments, the controller 415 may receive instructions from an external device (e.g., mobile device (used by an installer, for example), access control system, etc.) to set and/or externally control the transmit power of the BT beacon 410. In this way the broadcast area of the BT beacon 410 may be targeted to be optimized for various scenarios (short approaches, long approaches, different approach topologies, and the like).

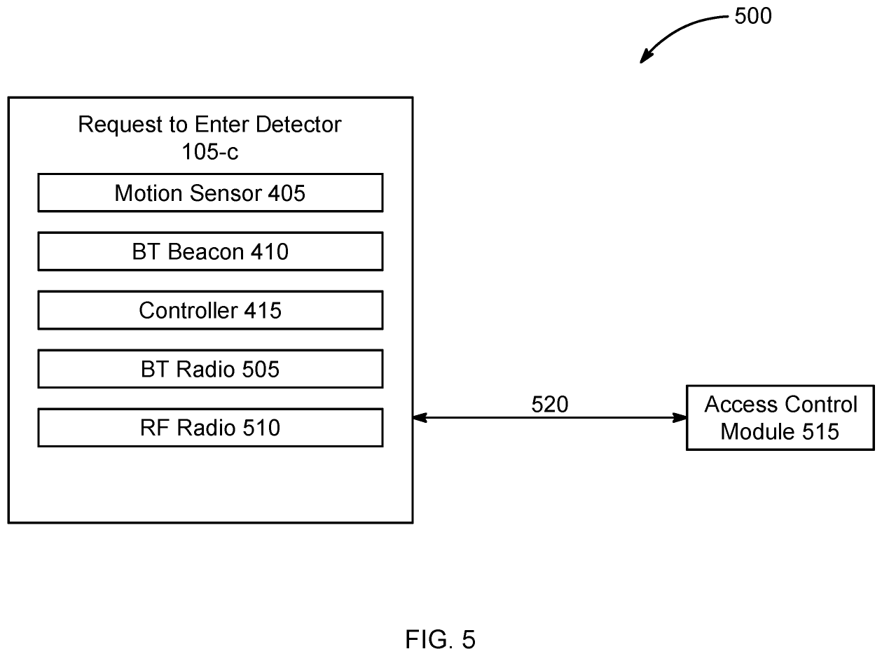

FIG. 5 is a block diagram illustrating an access control system 500 that includes a request to enter detector 105-c. The access control system 500 includes a request to enter detector 105-c and an access control module 515 that are connected via a first link 520.

The access control module 515 may be an electronically actuated locking mechanism (e.g., electric strike lock, electromagnetic lock, electric deadbolt, electronically controlled turnstile, and the like). In some embodiments, the access control module 515 may receive a data signal (via the first link 520) at a controller to unlock/lock and may enable/disable a relay that provides electrical power to the electronically actuated locking mechanism (whether electrical power is enabled/disabled depends on whether the electronically actuated locking mechanism is fail secure (e.g., Normally Closed (NC)) or fail safe (e.g., Normally Opened (NO)), for example). In other embodiments, the access control module 515 may receive/not receive electrical power (via the first link 520) at the electronically actuated locking mechanism that directly controls the electronically actuated locking mechanism (whether electrical power is enabled/disabled depends on whether the electronically actuated locking mechanism is fail secure (e.g., Normally Closed (NC)) or fail safe (e.g., Normally Opened (NO)), for example).

It is appreciated that certain electronically actuated locking mechanisms, such as electronically controlled turnstiles, ensure that authenticated access is only provided to a single authenticated user (eliminating the possibly of unauthorized users to “trailer” through a doorway behind an authorized user, for example). Accordingly, the electronically actuated locking mechanism may be selected to ensure that only authenticated users may access the enclosure.

The request to enter detector 105-c is one example of the request to enter detector 105 and request to enter detector 105-a illustrated in FIGS. 1 and 3. The request to enter detector 105-c includes a motion sensor 405 (e.g., motion sensor 320), a BT beacon 410, and a controller 415, as described with respect to FIG. 4. In addition, the request to enter detector 105-c includes a BT radio 505, and an RF radio 510.

The BT radio 505 is a Bluetooth® radio that is in a communication mode. In other words, the BT radio 505 is configured to receive connection requests from other BT devices and/or to establish communication sessions with other BT devices (e.g., phone, watch, tablet, mobile device). The BT radio 505 may have a different antenna design and/or transmit power than the BT beacon 410. In some embodiments, the BT radio 505 may not advertise its availability (i.e., the BT radio 505 may not be discoverable to other BT devices that are searching for available BT connections). The antenna design and/or transmit power may be configured differently than the BT beacon 410 (so as to be larger and/or have a more unidirectional broadcast area than the broadcast area of the BT beacon 410, for example) because the BT radio 505 is configured to receive connection requests from BT devices in response to an actionable notification triggered by a beacon message from the BT beacon 410 (and does not send out advertisements (e.g., notification producing advertisements, any advertisements on channels 37-39), including beacon messages, for example). The BT radio 505 may be separate and independent from the BT beacon 410.

In some embodiments, the BT radio 505 may receive an authentication token from the other BT device via a class 1 token exchange. In one example, a class 1 connection request is sent by the BT device, which includes sufficient information (e.g., token, a UUID of the BT device, for example) for the controller to authenticate the BT device. In another example, a class 1 connection is established between the BT radio 505 and the BT device and an authentication token is exchanged between the BT device and the BT radio 505 via the established class 1 connection.

In some cases, such as when multiple BT radio's are within range of a connection request, the controller that manages the BT radio 505 may compare the signal strength (e.g., received signal strength indicator (RSSI)) of a connection request as received by a BT radio 505 and only act on a connection request that has a highest signal strength among the multiple BT radios to ensure that the connection request is handled by the appropriate BT radio 505 (i.e., the BT radio 505 associated with the request to enter detector 105/doorway 110 that entry is requested at).

The RF radio 510 is a medium-distance or long-distance wireless radio for backhaul to an access control system. For example, the RF radio 510 may be a 900-megahertz (MHz) radio, 2.4 gigahertz (GHz), or 5 GHz. In some embodiments, the RF radio 510 may use chirp spread spectrum and/or chirp division multiplexing for communication. In other embodiments, the RF radio 510 may implement one of the Institute of Electrical and Electronics Engineers (IEEE) 802 set of local area network (LAN) communication protocols (e.g., 802.11). The RF radio 510 may enable centralized control/tracking of the access control module 515 by an access control system. For instance, the RF radio 510 may enable remote actuation of the access control module 515, centralized authorization, centralized access logging and tracking, and the like.

In some embodiments, the RF radio 510 operates in the 800 MHz-1000 MHz frequency range (e.g., 902 MHz-928 MHz (the industrial scientific, and medical (ISM) radio band in the U.S., for example), 863 MHz-870 MHz (a license free band in Europe, for example)) and target data rates in the 300 bps to 10 kbps range to allow for maximum range and reliability in that frequency range. In other embodiments, the RF radio 510 may operate in any of a variety of other frequency ranges (e.g., 433.05 MHz-434.79 MHz, 2.4 GHz-2.5 GHz, 5.725 GHz-5.875 GHz, 24 GHz-24.25 GHz, in the ISM radio bands, for example) and target data rates to allow for maximum range and reliability in those respective frequency ranges.

As noted above, the RF radio 510 may use chirp division multiplexing. Chirp division multiplexing is characterized by strategic usage of combinations of spreading factors and chirp bandwidth. It is appreciated that different combinations of spreading factors and chirp bandwidth can have similar throughput. For example, the combination of Spreading Factor 12 with a 500 KHz chirp bandwidth has approximately similar throughput as Spreading Factor 11 with 250 KHz chirp bandwidth. It is further appreciated that different Spreading Factors (as implemented, for example) are orthogonal to each other, regardless of the chirp bandwidth being used. Chirp division multiplexing leverages these aspects of orthogonality and similar throughput rates to multiplex different data streams having different spreading factors on the same frequency resources. Accordingly, the RF radio 510 may select a Spreading Factor and a chirp bandwidth size to optimize streaming throughput given the available frequency resources, through the use of chirp division multiplexing.

In the access control system 500, the controller 415 may perform additional functions such as managing authorization using the BT radio 505 and communication with the access control system using the RF radio 510. For example, as described herein, in response to a motion event detected by the motion sensor 405, the controller 415 enables the BT beacon 410, which broadcasts beacon messages until the controller 415 disables the BT beacon 410. Continuing with this example, the controller 415 monitors the BT radio 505 for a connection request from a BT device (a connection request sent by the BT device in response to an input to an actionable notification triggered by a beacon message, for example). The controller 415 may authenticate the BT device and authorize/deny access to the BT device based solely on information (e.g., the UUID of the BT device) contained in the connection request. Alternatively, the controller 415 may authenticate the BT device and authorize/deny access to the BT device based on information received during a communication session established between the BT device and the BT radio 505.

In some embodiments, the controller 415 and/or the access control system may ensure that all authentication criteria is met prior to allowing access. For example, the controller 415 and/or the access control system may check additional authentication attributes (via third party cloud services, for example) prior to authenticating access. In one example, the additional authentication attributes include health information. For example, the health information may ensure that the user is healthy (does not have a fever and/or does not have a contagious/communicable disease, for example) before authenticating access. This may be beneficial to restrict access (both in terms of authorization to enter and to ensure that even if otherwise authorized to enter, that certain health requirements are also met/strictly adhered to) to ensure that only healthy individuals enter areas where health is a concern (e.g., hospitals, nursing homes, assisted living centers, food production facilities, airplanes, boats, trains, public areas, stores, etc.). In other words, by further basing authentication decisions on additional data (e.g., health data), access control can protect against other threats (e.g., health threats) by restricting access to only authorized users that satisfy certain health conditions. It is appreciated that health attributes may be determined based on temperature detection systems, smart toilets, disease identification lists, and the like.

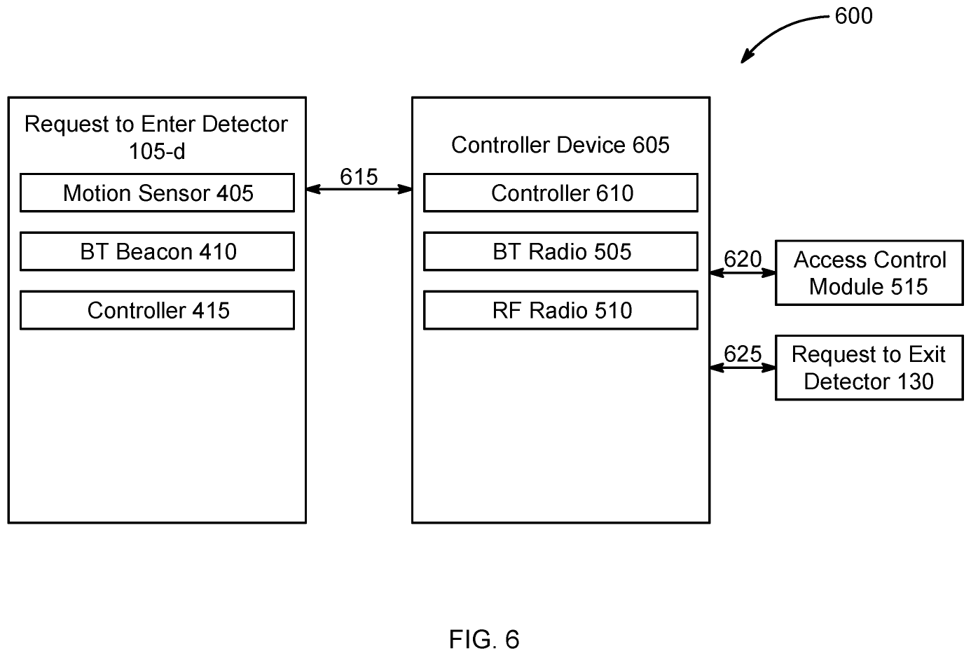

FIG. 6 is a block diagram illustrating another access control system 600 that includes a request to enter detector 105-d. The access control system 600 includes a request to enter detector 105-d, a controller device 605, and an access control module 515. The request to enter detector 105-d is connected to the controller device 605 via a first link 615 (e.g., a simple 2 wire connection with 2 power wires, a simple 4 wire connection with 2 power wires and 2 data wires (providing basic NC or NO data similar to the request to exit detector 130, for example), or an ethernet connection with power over ethernet (POE) or separate power). The controller device 605 is connected to the access control module 515 via a second link 620. The controller device 605 may optionally be connected to a request to exit detector 130 via a third link 625.

Whereas in FIG. 5, the request to enter detector 105-c included additional features (e.g., BT radio 505 and RF radio 510, with the controller 415 performing additional functions) so as to integrate access control features into the request to enter detector 105-c itself, FIG. 6 offloads the access control features to a controller device 605 that manages access control. As noted previously, the controller device 605 may be installed within the enclosure and implemented in the exit sign 135 or control box 145 as discussed in FIG. 2.

The controller device 605 may include its own controller 610 that manages access control functions. The controller device 605 includes the BT radio 505 and RF radio 510 discussed with respect to FIG. 5.

In the access control system 600, the BT beacon 410 may broadcast beacon messages for a predetermined time following a motion event detected by the motion sensor 405. A BT device with the appropriate application installed may receive a beacon message and may identify information for connecting to the BT radio 505 based on the beacon message. The BT radio 505 may receive a connection request from the BT device and provide authenticating information (e.g., a UUID contained in the connection request and/or a digital key exchanged via an established connection with the BT device) to the controller 610. The controller 610 authorizes or denies access based on the authenticating information received by the controller 610. In some embodiments, the controller 610 provides the authenticating information to a central access control system database that makes the access control determinations. In other embodiments (to save time, for example), the controller 610 may make initial access determinations based on the authenticating information and may report the authenticating information and/or the access decision made to the central access control system.

Based on the determined access decision, the controller 610 enables/disables access via the access control module 515. As noted previously, motion detected by the request to exit detector 130 may cause the controller device 605 to enable egress without access control. In some embodiments, egress is tracked via BT signals received by the BT radio 505 as BT device egress. Accordingly, the describe systems and methods may be enable smooth and efficient access control using a request to enter detector 105, beacon message transmissions, and a user's BT device.

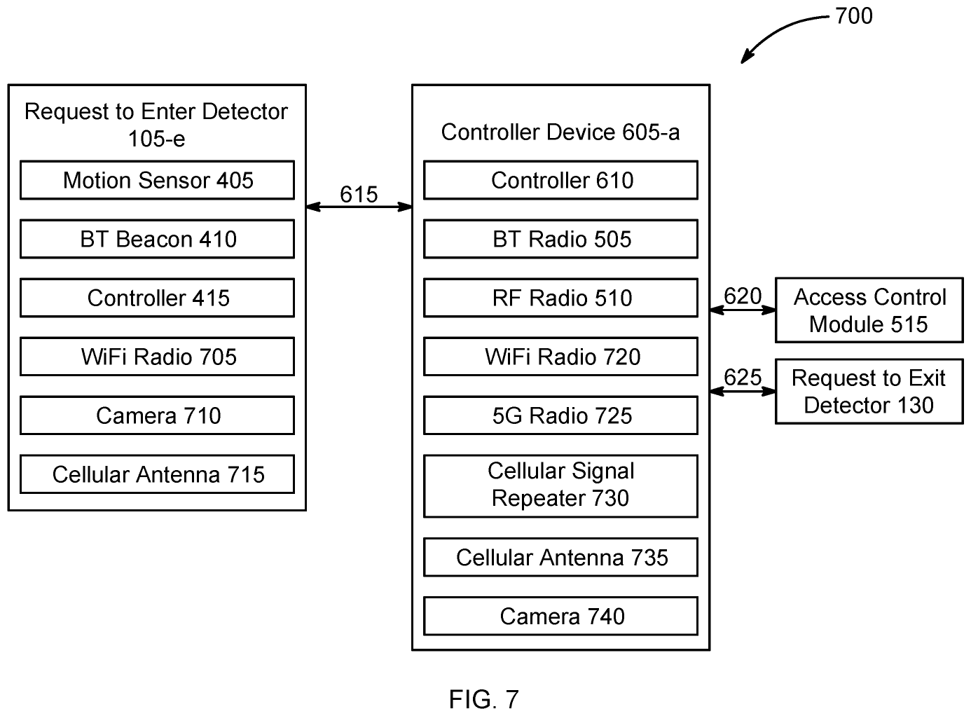

FIG. 7 is a block diagram illustrating another access control system 700 that includes a request to enter detector 105-e. The access control system 700 includes a request to enter detector 105-e, a controller device 605-a, and an access control module 515. The access control system 700 is similar to the access control system 600 except that access control system 700 includes additional features are included in both the request to enter detector 105-e and the controller device 605-a.

Due to the placement of the request to enter detector 105-e outside the enclosure, the request to enter detector 105-e may be ideally suited to provide wireless communications to the area outside the enclosure (e.g., outdoors) and/or to bridge wireless signals that are outdoors (e.g., cellular signals) to areas within the enclosure. Infrastructure (e.g., walls, ceilings, roofs) often attenuates wireless signals. By including wireless radios/antennas in the request to enter detector 105-e, desired features such as outdoor Wi-Fi, outdoor cameras, and/or cellular repeater antennas may be easily installed in a single externally facing device that is already being installed for access control purposes.

Similarly, the controller device 605 may be well suited to provide wireless communications to the are inside the enclosure (especially in view of the controller device 605 being installed in an elevated position just below (e.g., the exit sign 135) or just above (e.g., the control box 145) the ceiling, for example). Accordingly, the controller device 605 may similarly include wireless radios, cellular repeaters, and/or cameras. Except for the cellular signal repeater that includes a cellular antenna 715 in the request to enter detector 105-e and the cellular signal repeater 735 and cellular antenna 735 in the controller device 605-a, which requires components in both the request to enter detector 105-e and the controller device 605-a, the other wireless devices and/or cameras may be selectively be implemented in the request to enter device 105-e and/or the controller device 605-a as desired.

The benefit of incorporating these features into the request to enter detector 105-e and/or the controller device 605-a is that there is ready power and communication in place for access control, so the inclusion of additional features enables these additional features to be available without additional wiring and/or labor costs. In other words, integrating additional features enhances the value proposition of device(s) and eliminates the costly expense of bringing in different vendors to provide individualized solutions, each requiring separate cost and separate installation expense.

The request to enter detector 105-e may include a Wi-Fi radio 705, a camera 710, and/or a cellular antenna 715. The Wi-Fi radio 705 may provide Wi-Fi (IEEE 802.11) connectivity to devices external to the enclosure. Since the request to enter detector 105-e is mounted external to the enclosure, the Wi-Fi radio 705 may provide unobstructed Wi-Fi access to devices external to the enclosure. The camera 710 may be integrated into the request to enter detector 105-e so as to provide video surveillance of an area external to the enclosure (an area corresponding to the coverage area of the motion sensor 405, for example).

The cellular antenna 715 may receive cellular signals from a cellular tower and may provide the cellular signals to a cellular signal repeater 730, which repeats the cellular signals via a separate cellular antenna 735. Similarly, the cellular antenna 715 may transmit cellular signals provided from the cellular signal repeater 730, which repeats cellular signals received via the separate cellular antenna 735. Accordingly, the cellular antenna 715 in combination with the cellular signal repeater 730 and the cellular antenna 735 may enable cellular signals that are available outside of an enclosure to be repeated (and boosted) inside the enclosure. Including these components in the request to enter detector 105-e and the controller device 605-a is exceptionally efficient because it provides ideal locations for cellular antennas both external and internal to the enclosure.

The controller device 605-a may similarly include a Wi-Fi radio 720, a 5G radio 725, the cellular signal repeater 730, the cellular antenna 735, and/or a camera 740. The Wi-Fi radio 720 (like the Wi-Fi radio 705, for example) may provide Wi-Fi (IEEE 802.11) connectivity to devices internal to the enclosure. Since the controller device 605-a is mounted (in an elevated position, for example) inside the enclosure, the Wi-Fi radio 720 may provide unobstructed Wi-Fi access to devices internal to the enclosure. The 5G radio 725 may provide wireless connectivity us 5G technology (e.g., using millimeter wave signals (i.e., 24-86 Ghz). Because of the poor propagation features of millimeter wave signals, the placement of the controller device 605-a in an elevated position inside the enclosure maximizes the usability of the 5G radio 725. As discussed above, the cellular signal repeater 730 and cellular antenna 735 enable cellular signals that are available outside of the enclosure to be repeated/boosted within the enclosure. The camera 740 may be integrated into the controller device 605-a to provide video surveillance of an area internal to the enclosure.

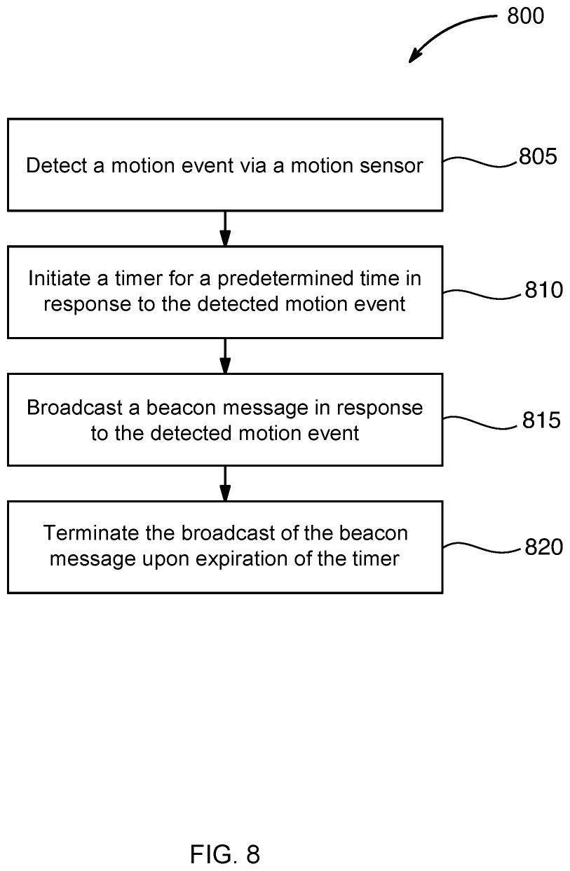

FIG. 8 is flow diagram illustrating one example of a method 800 for motion-based beacon advertisement. The method 800 may be implemented by a request to enter detector (e.g., request to enter detector 105) and more specifically by an application specific processor (e.g., controller 415) included within the request to enter detector.

At 805, a motion event is detected via a motion sensor. At 810, a timer is initiated for a predetermined time in response to the detected motion event. At 815, a beacon message is broadcast in response to the detected motion event. At 820, the broadcast of the beacon message is terminated upon the expiration of the timer. Accordingly, the beacon message is only broadcast while the timer is counting down.

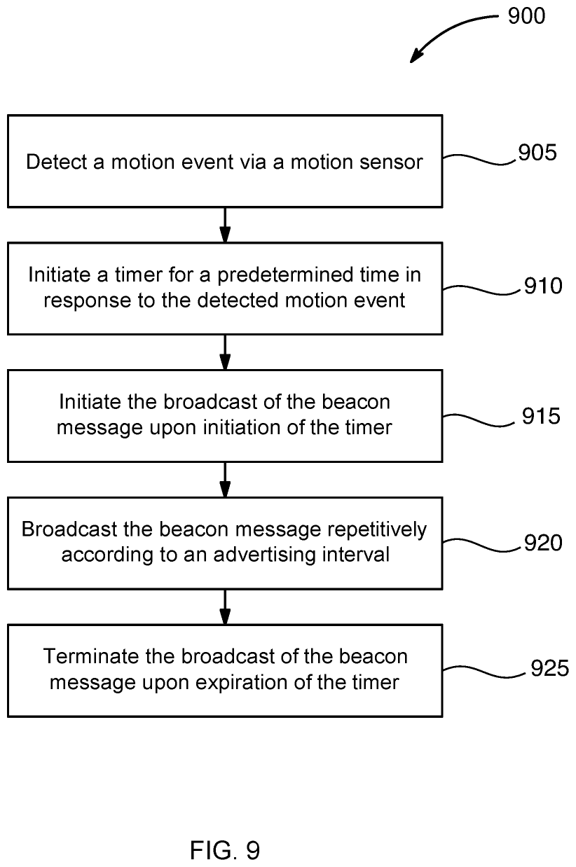

FIG. 9 is flow diagram illustrating another example of a method 900 for motion-based beacon advertisement. The method 900 may be implemented by a request to enter detector (e.g., request to enter detector 105) and more specifically by an application specific processor (e.g., controller 415) included within the request to enter detector.

At 905, a motion event is detected via a motion sensor. At 910, a timer is initiated for a predetermined time in response to the detected motion event. At 915, a broadcast of a beacon message is initiated upon initiation of the timer. At 920, the beacon message is broadcast repetitively according to an advertising interval. At 925, the broadcast of the beacon message is terminated upon the expiration of the timer.

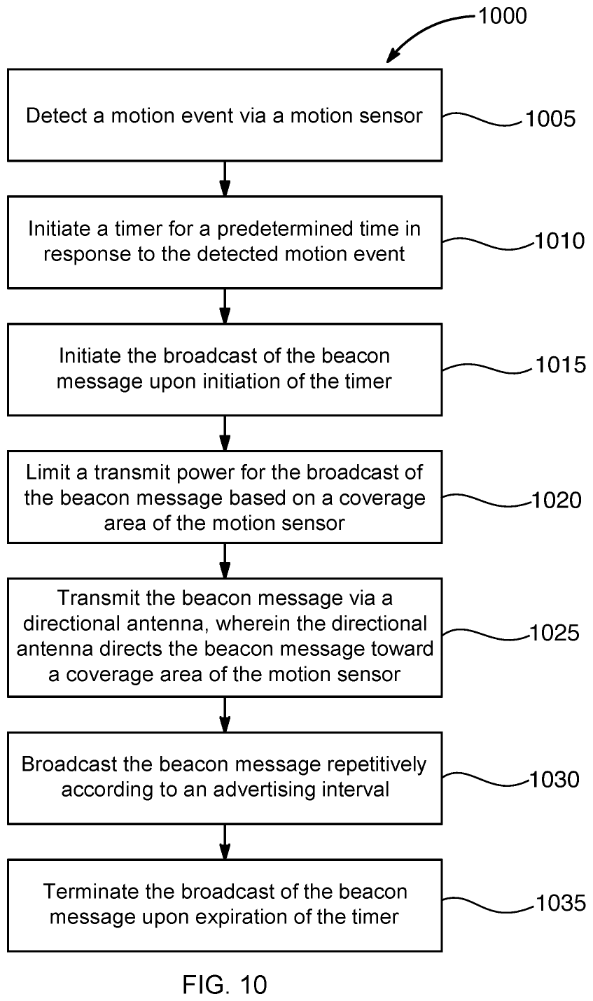

FIG. 10 is flow diagram illustrating yet another example of a method 1000 for motion-based beacon advertisement. The method 1000 may be implemented by a request to enter detector (e.g., request to enter detector 105) and more specifically by an application specific processor (e.g., controller 415) included within the request to enter detector.

At 1005, a motion event is detected via a motion sensor. At 1010, a timer is initiated for a predetermined time in response to the detected motion event. At 1015, a broadcast of a beacon message is initiated upon initiation of the timer. At 1020, a transmit power for the broadcast of the beacon message is limited based on a coverage area of the motion sensor. At 1025 the beacon message is transmitted via a directional antenna. The directional antenna directs the beacon message toward the coverage area of the motion sensor. At 1030, the beacon message is broadcast repetitively according to an advertising interval. At 1035, the broadcast of the beacon message is terminated upon the expiration of the timer.

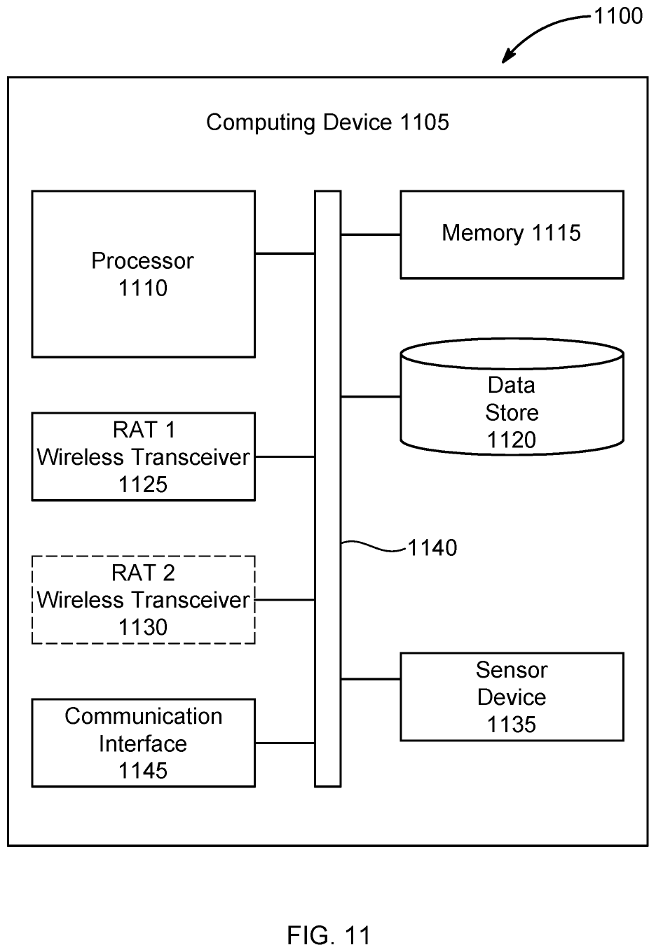

FIG. 11 is a block diagram 1100 of a computing device 1105 for implementing the described systems and methods. In some embodiments, the request to enter detector 105 (e.g., request to enter detector 105-a, 105-b, 105-c, 105-d, 105-e) may be examples of the computing device 1105. In some embodiments, the computing device 1105 may be an example of the BT device (e.g., phone, watch, tablet, mobile device) described herein.

The computing device 1105 includes a processor 1110 (including a general-purpose processor and one or more application specific processors, for example), a wireless transceiver 1125 for communicating via a first RAT (e.g., Bluetooth)), an optional wireless transceiver 1130 for communicating via a second RAT (e.g., 3G, 4G, LTE, 5G-NR, Wi-Fi, and/or LoRaWAN), a communication interface 845 (e.g., serial interface, 2-wire (e.g., NC, NO indicator circuit), ethernet, peripheral component interconnect express), a memory 1115 (e.g., random access memory (RAM), non-volatile RAM (NVRAM)), data store 1120 (e.g., hard disk drive, solid state disk), a sensor device 1135 (e.g., motion sensor), and an interconnect or bus 1140 for interconnecting each of the components 1110-1135 and 1145.

In some embodiments, the memory 1115 and/or the data store 1120 (each being a non-transitory storage medium, for example) may store instructions that are executable by the processor 1110 to implement the systems and methods described herein. For example, the instructions may be executable by the processor 1110 to implement any of the methods (e.g., method 800, 900, and/or method 1000).

The invention has been described with reference to various specific and preferred embodiments and techniques. Nevertheless, it is understood that many variations and modifications may be made while remaining within the spirit and scope of the invention.

What is claimed is:

1. A method for motion-based beacon advertisement, comprising:
detecting a motion event via a motion sensor;
initiating a timer for a predetermined time in response to the detected motion event;
broadcasting a beacon message in response to the detected motion event; and
terminating the broadcast of the beacon message upon expiration of the timer.

2. The method of claim 1, wherein the beacon message comprises a Bluetooth Low Energy (BLE) advertisement frame.

3. The method of claim 2, wherein the Bluetooth advertising frame comprises a data payload that includes a byte sequence associated with a beacon format, and wherein the beacon format is one of an AltBeacon format, iBeacon format, or Eddystone format.

4. The method of claim 1, wherein broadcasting the beacon message comprises repetitively broadcasting the beacon message according to an advertising interval.

5. The method of claim 1, further comprising:
initiating the broadcast of the beacon message upon initiation of the timer.

6. The method of claim 1, further comprising:
limiting a transmit power for the broadcast of the beacon message based on a coverage area of the motion sensor.

7. The method of claim 1, further comprising:
transmitting the beacon message via a directional antenna, wherein the directional antenna directs the beacon message toward a coverage area of the motion sensor.

8. The method of claim 1, wherein the predetermined time is less than 30 seconds.

9. The method of claim 1, wherein the predetermined time is less than 10 seconds.

10. The method of claim 1, wherein detecting a motion event comprises detecting a motion event in an external area to an access barrier, and wherein the access barrier separates the external area from an internal area.

11. A device for motion-based beacon advertisement, comprising:
a motion sensor;
a Bluetooth radio;
a processor; and
memory in electronic communication with the processor, wherein the memory stores instructions that when executed by the processor cause the processor to:
detect a motion event via the motion sensor;
initiate a timer for a predetermined time in response to the detected motion event;
broadcast a beacon message via the Bluetooth radio in response to the detected motion event; and
terminate the broadcast of the beacon message upon expiration of the timer.

12. The device of claim 11, wherein the beacon message comprises a Bluetooth Low Energy (BLE) advertisement frame.

13. The device of claim 12, wherein the Bluetooth advertising frame comprises a data payload that includes a byte sequence associated with a beacon format, and wherein the beacon format is one of an AltBeacon format, iBeacon format, or Eddystone format.

14. The device of claim 11, wherein the instructions to broadcast the beacon message comprise instructions that are executable by the processor to repetitively broadcast the beacon message according to an advertising interval.

15. The device of claim 11, wherein the instructions are further executable by the processor to:
initiate the broadcast of the beacon message upon initiation of the timer.

16. The device of claim 11, wherein the instructions are further executable by the processor to:
limit a transmit power for the broadcast of the beacon message based on a coverage area of the motion sensor.

17. The device of claim 11, wherein the instructions are further executable by the processor to:
transmit the beacon message via a directional antenna, wherein the directional antenna directs the beacon message toward a coverage area of the motion sensor.

18. The device of claim 11, wherein the predetermined time is less than 30 seconds.

19. The device of claim 11, wherein the predetermined time is less than 10 seconds.

20. The device of claim 11, wherein the instructions to detect a motion event comprises instructions that when executed by the processor cause the processor to detect a motion event in an external area to an access barrier, and wherein the access barrier separates the external area from an internal area.
